(19) United States
(12) Patent Application Publication
(10) Pub. No.: US 2019/0097198 A1
(43) Pub. Date: Mar. 28, 2019

(54) SEPARATOR FOR NONAQUEOUS ELECTROLYTE SECONDARY BATTERY AND NONAQUEOUS ELECTROLYTE SECONDARY BATTERY

(71) Applicant: NIPPON SHEET GLASS COMPANY, LIMITED, Tokyo (JP)

(72) Inventors: Takahiro OHARA, Tokyo (JP); Yuji KATAGIRI, Tokyo (JP); Masaki ONISHI, Tokyo (JP)

(73) Assignee: NIPPON SHEET GLASS COMPANY, LIMITED, Tokyo (JP)

(21) Appl. No.: 16/081,123

(22) PCT Filed: Feb. 10, 2017
(86) PCT No.: PCT/JP2017/004909

§ 371 Date: Aug. 30, 2018

(30) Foreign Application Priority Data
Mar. 1, 2016 (JP) 2016-038616

(51) Int. Cl. H01M 2/16; H01M 10/05

(52) U.S. Cl. CPC H01M 2/1613; H01M 10/05

(57) ABSTRACT

To provide a separator that has a strength preventing cracks from being formed in the production of a wound battery irrespective of a thin profile thereof, has high discharge rate characteristics, and has resistance to the formation of hydrofluoric acid due to the thermal decomposition of the electrolytic solution in high-temperature storage.

A separator for a nonaqueous electrolyte secondary battery and a nonaqueous electrolyte secondary battery comprising the separator, wherein the separator comprising mainly glass fibers having added thereto MgO as an additive, the separator having a thickness of 45 μm or less, a winding breakage strength of 1.2 kg or more, an anti-short-circuit strength of 1.0 kgf or more, and a separator resistance of 1.0 ohm or less.

### TECHNICAL FIELD

The present invention relates to a separator for a nonaqueous electrolyte secondary battery, formed of a nonwoven fabric mainly containing glass fibers, and a nonaqueous electrolyte secondary battery using the separator.

### BACKGROUND ART

Development of a large-sized lithium ion battery for industrial used or to be mounted on electric vehicles is proceeding in recent years, and the lithium ion battery necessarily has high discharge rate characteristics, i.e., a large discharge capacity even under large current. A resin fine porous membrane separator has been used as a separator for the lithium ion battery, but the battery using the resin fine porous membrane separator has a problem of severe decrease of the discharge capacity under a large current. In particular, the decrease of the discharge capacity becomes conspicuous in the case where an electrolytic solution having high viscosity, such as an ionic liquid, is used, or in the use thereof at a low temperature where the viscosity of the electrolytic solution is increased.

A separator using inorganic oxide fibers, such as glass fibers, can retain the insulation function in thermal runaway of the battery since the separator undergoes small contraction in the thermal runaway and has a sufficiently high melting temperature, contributing to high safety of the battery, and has good wettability to an electrolytic solution and thus is advantageous to the discharge rate characteristics with an electrolytic solution having high viscosity.

Furthermore, PTL 1 proposes a separator using a glass fiber nonwoven fabric and describes that the separator is further advantageous since a high porosity is obtained with the glass fiber nonwoven fabric to retain a larger amount of the electrolytic solution.

As for the separator using glass fiber, the high-temperature storage characteristics may be decreased in some cases since hydrofluoric acid (HF) is formed through thermal decomposition of the electrolytic solution in storage at a high temperature, and undergoes chemical reaction with the glass fibers constituting the separator. For solving the problem, PTL 2 proposes to add magnesium oxide (MgO) to a separator containing glass fibers.

### CITATION LIST

### Patent Literature

PTL 1: JP-A-2010-287380
PTL 2: JP-A-2013-232357

### Non Patent Literature

NPL 1: The Fourteenth Annual Battery Conference on Applications and Advances, IEEE, p. 161 (1999)

### SUMMARY OF INVENTION

### Technical Problem

PTL 1 proposes a separator formed of a nonwoven fabric containing glass fibers applied to an electrolytic solution using an ionic liquid, but the separators containing glass fibers described in the examples thereof have a problem that the volume energy density of the battery is decreased due to the large thickness of 100 μm thereof, and the decrease of the thickness of the separator makes the strength thereof insufficient, which may cause formation of breakage and cracks therein in the production of a wound battery.

The present invention has been made in focus to the existing problems, and an object thereof is to provide a separator containing glass fibers as a constitutional material, that has a strength preventing cracks from being formed in the production of a wound battery irrespective of a thin profile thereof, has high discharge rate characteristics, and has resistance to the formation of hydrofluoric acid due to the thermal decomposition of the electrolytic solution in high-temperature storage.

### Solution to Problem

A separator for a nonaqueous electrolyte secondary battery of the present invention, comprising mainly glass fibers having added thereto MgO as an additive, the separator having a thickness of 45 μm or less, a winding breakage strength of 1.2 kg or more, an anti-short-circuit strength of 1.0 kgf or more, and a separator resistance of 1.0 ohm or less.

The separator for a nonaqueous electrolyte secondary battery of the present invention, wherein the winding breakage strength is 1.5 kg or more.

The separator for a nonaqueous electrolyte secondary battery of the present invention, wherein the anti-short-circuit strength is 2.6 kgf or more.

The separator for a nonaqueous electrolyte secondary battery of the present invention, wherein the separator resistance is 0.8 ohm or less.

The separator for a nonaqueous electrolyte secondary battery of the present invention, wherein the glass fibers have an average fiber diameter of 0.4 μm or more and 0.8 μm or less.

The separator for a nonaqueous electrolyte secondary battery of the present invention, wherein the glass fibers contain glass fibers having an average fiber diameter of 0.2 μm or more and 0.4 μm or less and glass fibers having an average fiber diameter of 0.5 μm or more and 0.8 μm or less, which are mixed with each other.

The separator for a nonaqueous electrolyte secondary battery of the present invention, wherein a content of the glass fibers is 60% by mass or more and 90% by mass or less based on the total amount of fibers.

The separator for a nonaqueous electrolyte secondary battery of the present invention, wherein the separator contains organic fibers in an amount of 1% by mass or more and 35% by mass or less based on the total amount of fibers, and contains a binder in an amount of 5% by mass or more and 35% by mass or less based on a mass obtained by subtracting a mass of the MgO from the total mass of the separator.

The separator for a nonaqueous electrolyte secondary battery of the present invention, wherein the organic fibers contain fibrillated organic fibers in an amount of 1% by mass or more and 10% by mass or less based on the total amount of fibers.

The separator for a nonaqueous electrolyte secondary battery of the present invention, wherein the MgO is added to make a product of a specific surface area by the BET method (m²/g) and a addition proportion by mass (wt %) with respect to the whole glass fiber of 300 ((m/g)·(wt %)) or more.

A nonaqueous electrolyte secondary battery of the present invention comprising the separator for a nonaqueous electrolyte secondary battery described in any of the above.

### Advantageous Effects of Invention

The separator of the present invention has a strength preventing cracks from being formed in the production of a wound battery irrespective of a thin profile thereof, has high discharge rate characteristics, and has resistance to the formation of hydrofluoric acid due to the thermal decomposition of the electrolytic solution in high-temperature storage. The nonaqueous electrolyte secondary battery of the present invention has good discharge rate characteristics and causes no short-circuit in the operation of the battery.

### BRIEF DESCRIPTION OF DRAWINGS

FIG. 1 is an explanatory illustration of the measurement method for the winding breakage strength (in which (A) is a plane view, and (B) is a side view).

FIG. 2 is an explanatory illustration showing the production method of a lithium ion secondary battery, which is one kind of a nonaqueous electrolyte secondary battery.

### DESCRIPTION OF EMBODIMENTS

### Separator Thickness

The thickness of the separator for a nonaqueous electrolyte secondary battery of the present invention can be measured by using a micrometer (Mitsutoyo CLM1-15QM) with a measurement force of 2 N. With a thickness of the separator that is 45 μm or less, the battery can ensure a practical volume energy density.

### Winding Breakage Strength

In the present invention, the conception of a winding breakage strength is used as an index for evaluating the strength of the separator in the production of a wound battery. The test method thereof approximates the actual production method of a wound battery, and the possibility of breakage in the production of a wound battery can be accurately evaluated by using the index. With a high winding breakage strength, the breakage due to the tension in winding and the breakage and cracks formed with the edge of the electrode tab of the shaft portion are prevented from occurring. For retaining the strength of the separator against winding to prevent the breakage and cracks from occurring in the production of a wound battery, and for preventing the short-circuit from occurring in the operation of a battery, the winding breakage strength is necessarily 1.2 kg or more, and preferably 1.5 kg or more.

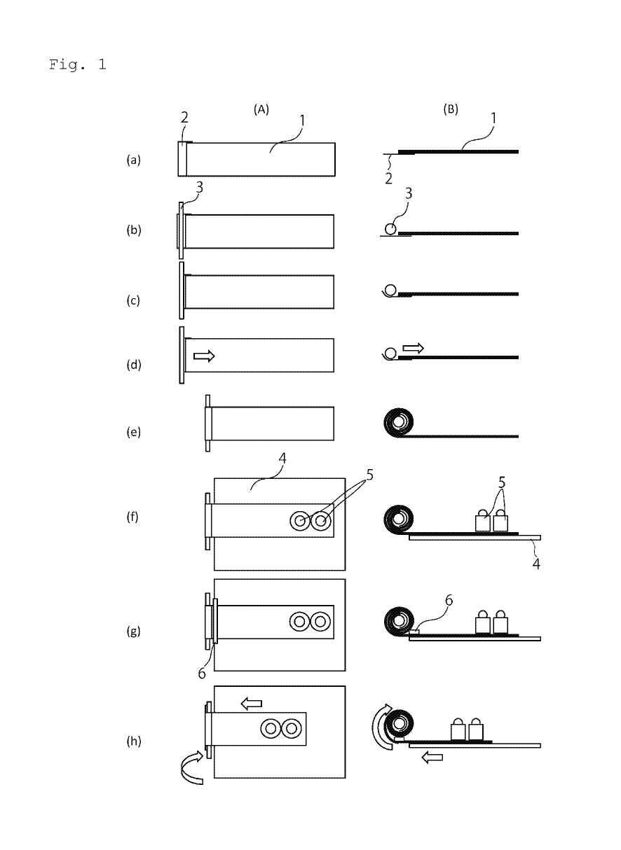

The winding breakage strength can be measured by the method described in FIG. 1. A separator specimen 1 having a size of 60×250 mm is prepared. The longitudinal edge is directed to the MD. The MD herein is an abbreviation of the machine direction, and means the flow direction in paper making by the wet nonwoven fabric production method. A cellophane adhesive tape 2 (15 mm in width×60 mm in length) was adhered to one of the short edges of the specimen 1 in such a manner that 7.5 mm in the 15 mm width overlaps the specimen 1 (see FIG. 1(a)).

Subsequently, the assembly is placed to make the adhesive surface of the cellophane adhesive tape 2 directed upward, and a round bar 3 formed of SUS304 having a diameter of 4.5 mm and a length of 160 mm is placed on the adhesive surface (see FIG. 1(b)). The portion of the cellophane adhesive tape 2 that does not overlap the specimen 1 is adhered to the round bar 3 (see FIG. 1(c)).

Subsequently, the round bar 3 is rolled in the direction of the arrow (see FIG. 1(d)), and the specimen 1 is wound three turns (see FIG. 1(e)).

Subsequently, the specimen 1 is placed on a resin plate 4 (Cutting Mat, produced by Olfa Corporation, model No. 134B), and a weight 5 of 0.5 kg is placed on the center of the portion of the specimen 1 opposite to the portion thereof wound on the round bar 3 (see FIG. 1(f)).

Subsequently, a plate 6 formed of SUS304 having a size of 4 mm in width×80 mm in length×100 μm in thickness simulating an electrode tab is placed on the root portion of the specimen 1 wound on the round bar 3 (see FIG. 1(g)).

Subsequently, the SUS plate 6 is rolled up in the direction of the arrow by rolling the round bar 3 two turns at a rate of 2 seconds per one turn. At this time, the operation is performed in such a manner that the position of the round bar 3 is not moved, but the weight 5 is moved (see FIG. 1(h)).

Then, the specimen 1 is wound off and confirmed for the presence of breakage and cracks. In the case where no breakage or crack is found, another new specimen is evaluated by increasing the load of the weight 5 by 0.1 kg. The load of the weight 5, at which breakage or cracks are formed, is designated as the winding breakage strength. In the examples of the present invention, the average value obtained by repeating the aforementioned operations three times is designated as the winding breakage strength.

### Anti-Short-Circuit Strength

The anti-short-circuit strength can be measured according to the method described in NPL 1. For preventing short circuit from occurring, the anti-short-circuit strength is necessarily 1.0 kgf or more, and preferably 2.6 kgf or more. In the examples of the present invention, the anti-short-circuit strength is measured in the following manner.

A lithium cobaltate sheet, produced by Hohsen Corporation, is prepared as a positive electrode, and a natural spheroidal graphite sheet, produced by Hohsen Corporation, is prepared as a negative electrode. On a flat metal plate, the negative electrode, the separator specimen, and the positive electrode are disposed in this order. At this time, the electrodes each are disposed to make the active substance layer directed to the separator. For confirming short-circuit, a tester is attached to the positive electrode and the negative electrode. Subsequently, a probe having a spherical tip shape having a diameter of 3 mm is penetrated perpendicularly to the separator from above the positive electrode, and when it is confirmed that an electric current flows with the tester, the force applied to the probe is measured and designated as the anti-short-circuit strength.

### Separator Resistance

For achieving high discharge rate characteristics by sufficiently decreasing the internal resistance of the battery, the separator resistance is necessarily 1.0 ohm or less, and preferably 0.8 ohm or less.

The separator resistance can be measured by measuring the alternating-current impedance. In the examples of the present invention, the separator resistance is measured in the following manner.

The separator is mounted on a bipolar cell (produced by Toyo System Co., Ltd., Model No. TYS-00DM01, diameter of electrode: 16 mm), and 1 mL of an electrolytic solution that contains 1 mol/L of LiPF₆ is added to a solvent obtained by mixing ethylene carbonate (which is hereinafter abbreviated as EC) and ethyl methyl carbonate (which is hereinafter abbreviated as EMC) at a volume ratio of 1/3. The cell thus produced is measured for alternating-current impedance, and the intercept value on the high frequency side of the Nyquist plot is designated as the separator resistance.

### Porosity

The porosity, which is one of the separator characteristics, is preferably 70% or more and 90% or less for ensuring the sufficient mechanical strength while retaining the high rate characteristics.

The porosity can be obtained by the following expression (1), in which t represents the thickness obtained with a micrometer, W represents the basis weight, ρM represents the true densities of the constitutional materials, and cM represents the mass proportions of the constitutional materials.

Porosity (%)={1−W/t×Σ(cM/ρM)}×100 (1)

### Glass Fibers

The glass fibers used in the separator for a nonaqueous electrolyte secondary battery of the present invention may have any composition, and in particular, C-glass, E-glass, ECR-glass, S-glass, and silica glass are preferred. In the case where one kind of glass fibers are used, the glass fibers preferably have an average fiber diameter of 0.4 μm or more and 0.8 μm or less, and it is more preferred that two kinds of glass fibers having different average fiber diameters, i.e., glass fibers having an average fiber diameter of 0.2 μm or more and 0.4 μm or less and glass fibers having an average fiber diameter of 0.5 μm or more and 0.8 μm or less, are mixed. This is because, in general, glass fibers having a small fiber diameter enhance the tensile strength of the nonwoven fabric, and glass fibers having a large fiber diameter enhance the rigidity of the nonwoven fabric, thereby suppressing the deformation of the separator. However, when the amount of the glass fibers having a small fiber diameter is too large, the average pore diameter of the separator becomes too small, which deteriorates the discharge rate characteristics. On the other hand, when the fiber diameter is too large, or the amount of the glass fibers is too small, the average pore diameter becomes too large, which also deteriorates the discharge rate characteristics. The content of the glass fibers is preferably 60% by mass or more and 90% by mass or less, and more preferably 70% by mass or more and 90% by mass or less, based on the total amount of the fibers, for suppressing the contraction of the separator in thermal runaway, and for satisfying the sufficient winding breakage strength.

### Organic Fibers

Organic fibers are preferably added to the glass fibers for increasing the strength of the separator. The organic fibers include fibrillated fibers (which may be hereinafter referred to as fibrillated organic fibers) and normal fibers not fibrillated (which may be hereinafter referred to as non-fibrillated organic fibers), both of which may be used, and it is preferred to use the fibrillated organic fibers and the non-fibrillated organic fibers in combination for enhancing the strength. The content of the organic fibers is preferably 10% by mass or more and 25% by mass or less based on the total amount of the fibers.

In the fibrillated organic fibers, the respective fibers preferably have a fine fiber diameter of 1 μm or less through fibrillation, and the average fiber diameter more preferably becomes 0.1 μm or less.

The composition of the fibrillated organic fibers suffices to be electrochemically stable and also stable against the electrolytic solution. Examples thereof include cellulose fibers, aramid fibers, polyamide fibers, polyester fibers, polyurethane fibers, polyacrylic fibers, polyethylene fibers, and polypropylene fibers, and among these, cellulose fibers, aramid fibers, polyester fibers, polyethylene fibers, and polypropylene fibers are preferred. The fibers may be used solely or as a mixture of two or more kinds thereof. The use of the fibrillated organic fibers may increase the winding breakage strength and the anti-short-circuit strength, but when the content of the fibrillated organic fibers is large, the separator resistance may be increased to deteriorate the discharge rate characteristics. Accordingly, the content of the fibrillated organic fibers is preferably 1% by mass or more and 10% by mass or less, and more preferably 1% by mass or more and 8% by mass or less, based on the total amount of the fibers.

The addition of the non-fibrillated organic fibers may impart flexibility to the separator, and may enhance the winding breakage strength.

The non-fibrillated organic fibers may be fibers formed of a single composition or may be fibers formed of plural compositions, such as core-shell type fibers. The composition suffices to be electrochemically stable and also stable against the electrolytic solution. Examples thereof include cellulose fibers, aramid fibers, polyamide fibers, polyester fibers, polyurethane fibers, polyacrylic fibers, polyethylene fibers, and polypropylene fibers, and among these, cellulose fibers, aramid fibers, polyester fibers, polyethylene fibers, and polypropylene fibers are preferred. The non-fibrillated organic fibers may be used solely or as a mixture of two or more kinds thereof. The use of the mixture of fibers having different average fiber diameters may enhance the strength, but when the content of the non-fibrillated organic fibers is large, the thermal contraction in thermal runaway may be increased to deteriorate the safety. Accordingly, the content of the non-fibrillated organic fibers is preferably 5% by mass or more and 35% by mass or less, and more preferably 10% by mass or more and 30% by mass or less, based on the total amount of the fibers.

### Binder

In the separator for a nonaqueous electrolyte secondary battery, a binder is preferably used for the purpose of binding the fibers as a constitutional material and for the purpose of fixing the MgO. The binder suffices to be electrochemically stable and also stable against the electrolytic solution, and further to bind the constitutional material favorably, and examples thereof include EVA (having a content of the constitutional unit derived from vinyl acetate of from 20 to 35% by mol), an ethylene-acrylate copolymer, such as an ethylene-ethyl acrylate copolymer, various kinds of rubber and derivatives thereof (such as styrene-butadiene rubber (SBR), fluorine rubber, urethane rubber, and ethylene-propylene-diene rubber (EPDM)), a cellulose derivative (such as carboxymethyl cellulose (CMC), hydroxyethyl cellulose, and hydroxypropyl cellulose), polyvinyl alcohol (PVA), polyvinyl butyral (PVB), polyvinylpyrrolidone (PVP), polyurethane, an epoxy resin, polyvinylidene fluoride (PVDF), a vinylidene fluoride-hexafluoropropylene copolymer (PVDF-HFP), and an acrylic resin. In the use, these resins may be used solely or as a combination of two or more kinds thereof. When the amount of the binder is small, the winding breakage strength may be decreased due to the insufficient tensile strength, the anti-short-circuit strength may be decreased, and the MgO may be dropped off. However, when the amount of the binder is too large, the separator resistance is increased to deteriorate the discharge rate characteristics. Accordingly, the content of the binder used in the present invention is preferably 5% by mass or more and 35% by mass or less, and more preferably 10% by mass or more and 30% by mass or less, based on the mass obtained by subtracting the mass of the MgO from the total mass of the separator.

### MgO

As described in PTL 2 (JP-A-2013-232357), the amount of the MgO added preferably makes a product of the specific surface area by the BET method (m²/g) and the addition proportion by mass (wt %) of 300 ((m/g)·(wt %)) or more, and more preferably makes the product of 4,000 ((m/g)·(wt %)) or more. The addition proportion by mass (wt %) means the mass proportion of the additive with respect to the sum of the mass of the glass fibers and the mass of the MgO. The product of the specific surface area by the BET method (m²/g) and the addition proportion by mass (wt %) means the surface area of the additive per unit mass of the glass fibers. Specifically, the value means the extent of the effect of the MgO per unit mass of the glass fibers present in the electrolytic solution.

By adding the MgO in this manner, hydrofluoric acid formed is efficiently scavenged to relieve the influence of hydrofluoric acid to the glass substrate. Consequently, the high-temperature storage characteristics of the nonaqueous electrolyte secondary battery using the separator containing the glass fiber can be prevented from being deteriorated.

The lithium ion secondary battery as one kind of the nonaqueous electrolyte secondary battery of the present invention can be produced, for example, in the following manner.

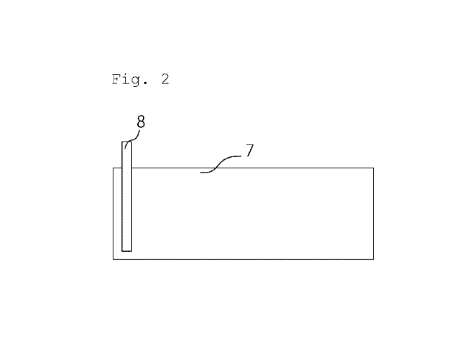

A positive electrode containing 85% by mass of LiCoO₂ as a positive electrode active substance, 7% by mass of carbon black as a conductive agent, and 8% by mass of polyvinylidene fluoride as a binder, and a negative electrode containing 86% by mass of natural spheroidal graphite as a negative electrode active substance, 6% by mass of carbon black as a conductive agent, and 8% by mass of polyvinylidene fluoride as a binder are used. By using an electrolytic solution containing 1 mol/L of LiPF₆ in a solvent obtained by mixing EC and EMC at a volume ratio of 1/3, the separator is disposed between the electrodes, and the assembly is wound into a spiral form to produce a 18650 cell. As shown in FIG. 2, the positive electrode and the negative electrode are coated on collectors 7 formed of an aluminum foil having a thickness of 15 μm and formed of a copper foil having a thickness of 10 μm, respectively, and on each of the back surfaces thereof, one electrode tab 8 having a width of 4 mm and a thickness of 100 μm is welded to one end in the longitudinal direction of the collector 7. In the production of the cell, the electrode tab of the positive electrode is disposed on the side of the shaft, and the electrode tab of the negative electrode is disposed outside the shaft.

The separator for a nonaqueous electrolyte secondary battery of the embodiment will be described with reference to examples. The present invention is not limited to the examples shown below.

### Example 1

75% by mass of glass fibers obtained by mixing C-glass short fibers having an average fiber diameter of 0.6 μm and C-glass short fibers having an average fiber diameter of 0.3 μm at a mass ratio of 3/1, 5% by mass of fibrillated cellulose fibers, and 20% by mass of polyester fibers having an average fiber diameter of 2 μm and a fiber length of 3 mm are dispersed in water, and a nonwoven fabric sheet having a basis weight of 5 g/m² was manufactured. A latex binder (AL-3001A, produced by Nippon A&L Inc.) was coated on the nonwoven fabric sheet to 1 g/m², and dried. Thereafter, as an additive, MgO powder (UCM-150, produced by Ube Material Industries, Ltd., average particle diameter: 3.3 μm, specific surface area by BET method: 176 m²/g) and polyvinylpyrrolidone (K-90, produced by Nippon Shokubai Co., Ltd., dispersed concentration: 5 parts per 100 parts of magnesium oxide powder) dispersed in dehydrated ethanol were coated in an amount of 50% by mass with respect to the mass after coating the additive, and dried. The assembly was pressed to a thickness of 30 μm, thereby providing a separator.

The glass short fibers used herein were produced by a flame method, and the fiber length thereof was approximately from 0.1 to 10 mm.

The separator characteristics of the separator thus produced were a winding breakage strength of 1.5 kg, an anti-short-circuit strength of 2.6 kgf, and a separator resistance of 0.8 ohm.

### Example 2

A separator was produced in the same manner as in Example 1 except that the amount of the binder coated was changed to 2 g/m².

The separator characteristics of the separator thus produced were a winding breakage strength of 2.0 kg, an anti-short-circuit strength of 3.0 kgf, and a separator resistance of 1.0 ohm.

### Example 3

A separator was produced in the same manner as in Example 1 except that 80% by mass of glass fibers obtained by mixing C-glass short fibers having an average fiber diameter of 0.6 μm and C-glass short fibers having an average fiber diameter of 0.3 μm at a mass ratio of 3/1 and 20% by mass of polyester fibers having an average fiber diameter of 2 μm were used for manufacturing a nonwoven fabric sheet.

The separator characteristics of the separator thus produced were a winding breakage strength of 1.2 kg, an anti-short-circuit strength of 1.0 kgf, and a separator resistance of 0.6 ohm.

### Comparative Example 1

A separator was produced in the same manner as in Example 1 except that 95% by mass of glass fibers obtained by mixing C-glass short fibers having an average fiber diameter of 0.6 μm and C-glass short fibers having an average fiber diameter of 0.3 μm at a mass ratio of 3/1 and 5% by mass of fibrillated cellulose fibers were used for manufacturing a nonwoven fabric sheet.

The separator characteristics of the separator thus produced were a winding breakage strength of 0.5 kg, an anti-short-circuit strength of 1.4 kgf, and a separator resistance of 0.8 ohm.

### Comparative Example 2

A separator was produced in the same manner as in Example 1 except that the binder was not coated, and the polyvinylpyrrolidone was not used on coating the MgO powder.

The separator characteristics of the separator thus produced were a winding breakage strength of 1.0 kg, an anti-short-circuit strength of 0.4 kgf, and a separator resistance of 0.6 ohm.

### Comparative Example 3

A separator was produced in the same manner as in Example 1 except that 70% by mass of glass fibers obtained by mixing C-glass short fibers having an average fiber diameter of 0.6 μm and C-glass short fibers having an average fiber diameter of 0.3 μm at a mass ratio of 3/1, 10% by mass of fibrillated cellulose fibers, and 20% by mass of polyester fibers having an average fiber diameter of 2 μm were used for manufacturing a nonwoven fabric sheet.

The separator characteristics of the separator thus produced were a winding breakage strength of 2.0 kg, an anti-short-circuit strength of 1.8 kgf, and a separator resistance of 1.2 ohm.

### Comparative Example 4

A separator was produced in the same manner as in Example 1 except that the amount of the binder coated was changed to 4 g/m².

The separator characteristics of the separator thus produced were a winding breakage strength of 2.0 kg, an anti-short-circuit strength of 3.0 kgf, and a separator resistance of 1.6 ohm.

Lithium ion secondary batteries of the aforementioned 18650 cell were produced by using the separators of Examples 1 to 3 and Comparative Examples 1 to 4, and evaluated for the following items of the characteristics thereof. The results are shown in Table 1.

### Capability of Winding

The capability of winding was evaluated in such a manner that in the production of the cylindrical cell, the separator that underwent breakage and cracks in 2 or more cells per 10 cells was evaluated as C, the separator that underwent breakage and cracks in 1 cell per 10 cells was evaluated as B, and the separator that underwent no breakage or crack was evaluated as A.

### Presence of Short-Circuit

The presence of short-circuit was evaluated in such a manner that in the charge and discharge test, the separator where all the cells were operated normally was evaluated as A, the separator where 2 or more cells per 10 cells failed to achieve voltage rise due to short-circuit was evaluated as C, and the separator where 1 cell per 10 cells failed to achieve voltage rise was evaluated as B.

### Battery Characteristics (Discharge Rate Characteristics)

By using a charge and discharge test device, 0.5 C CCCV charge, 0.2 C CC discharge, 0.5 C CCCV charge, and 10 C CC discharge were performed between 3.0 V and 4.2 V, and the charge retention rate of the 10 C discharge capacity with respect to the 0.2 C discharge capacity was obtained to evaluate the battery characteristics (discharge rate characteristics). In the evaluation, 60% or more was evaluated as A, 50% or more and less than 60% was evaluated as B, and less than 50% was evaluated as C.

TABLE 1

| | | | | | | Comparative | Comparative | Comparative | Comparative |
|---|---|---|---|---|---|---|---|---|---|
| | | | Example 1 | Example 2 | Example 3 | Example 1 | Example 2 | Example 3 | Example 4 |
| Separator | Thickness | (μm) | 30 | 30 | 30 | 30 | 30 | 30 | 30 |
| characteristics | Winding breakage | (kg) | 1.5 | 2.0 | 1.2 | 0.5 | 1.0 | 2.0 | 2.0 |
| | strength | | | | | | | | |
| | Anti-short-circuit | (kgf) | 2.6 | 3.0 | 1.0 | 1.4 | 0.4 | 1.8 | 3.0 |
| | strength | | | | | | | | |
| | Separator | (ohm) | 0.8 | 1.0 | 0.6 | 0.8 | 0.6 | 1.2 | 1.6 |
| | resistance | | | | | | | | |
| | Porosity | (%) | 83 | 78 | 83 | 84 | 87 | 82 | 69 |
| Constitutional | Glass fibers | 0.3 μm | 19 | 19 | 20 | 24 | 19 | 18 | 19 |
| material (%) | | 0.6 μm | 56 | 56 | 60 | 71 | 56 | 52 | 56 |
| | | Average fiber | 0.5 | 0.5 | 0.5 | 0.5 | 0.5 | 0.5 | 0.5 |
| | | diameter (μm) | | | | | | | |
| | Fibrillated cellulose fibers | | 5 | 5 | — | 5 | 5 | 10 | 5 |
| | PET fibers | | 20 | 20 | 20 | — | 20 | 20 | 20 |
| | Total of papermaking materials | | 100 | 100 | 100 | 100 | 100 | 100 | 100 |
| Mass after papermaking | | (g/m²) | 5 | 5 | 5 | 5 | 5 | 5 | 5 |
| Mass of | Latex | (g/m²) | 1 | 2 | 1 | 1 | — | 1 | 4 |
| binder | PVP | (g/m²) | 0.29 | 0.33 | 0.29 | 0.29 | — | 0.29 | 0.43 |
| | Total (A) | (g/m²) | 1.3 | 2.3 | 1.3 | 1.3 | — | 1.3 | 4.4 |

| | | | | | | | | |
|---|---|---|---|---|---|---|---|---|
| Mass of MgO | (g/m²) | 5.71 | 6.67 | 5.71 | 5.71 | 5.00 | 5.71 | 8.57 |
| Mass obtained by subtracting | (g/m²) | 6.3 | 7.3 | 6.3 | 6.3 | 5.0 | 6.3 | 9.4 |
| mass of MgO from total | | | | | | | | |
| mass of separator (B) | | | | | | | | |
| (A)/(B) | (%) | 20% | 32% | 20% | 20% | 0% | 20% | 47% |

| | | | | | | | | |
|---|---|---|---|---|---|---|---|---|
| Evaluation | Capability of winding | A | A | B | C | C | A | A |
| | Presence of short-circuit | A | A | A | A | C | A | A |
| | Battery characteristics | A | B | A | A | A | C | C |

In Comparative Examples 1 and 2, the evaluation of the capability of winding is C, and it is understood therefrom that when the winding breakage strength is 1.2 kg or more, the possibility of breakage in the production of the wound battery can be decreased, and when the winding breakage strength is 1.5 kg or more, the breakage can be prevented.

In Comparative Example 2, the evaluation of the presence of short-circuit is C, it is understood therefrom that when the anti-short-circuit strength is 1.0 kgf or more, a wound battery free of occurrence of short-circuit can be obtained.

In Comparative Examples 3 and 4, the evaluation of the battery characteristics (discharge rate characteristics) is C, and it is understood therefrom that when the separator resistance is 1.0 ohm or less, the battery characteristics can be enhanced, and when the separator resistance is 0.8 ohm or less, the battery characteristics can be further enhanced.

### REFERENCE SIGNS LIST

1 separator specimen
2 cellophane adhesive tape
3 SUS304 round bar
4 resin plate
5 weight
6 SUS304 plate
7 collector
8 electrode tab

1. A separator for a nonaqueous electrolyte secondary battery, comprising mainly glass fibers having added thereto MgO as an additive, the separator having a thickness of 45 μm or less, a winding breakage strength of 1.2 kg or more, an anti-short-circuit strength of 1.0 kgf or more, and a separator resistance of 1.0 ohm or less.

2. The separator for a nonaqueous electrolyte secondary battery according to claim 1, wherein the winding breakage strength is 1.5 kg or more.

3. The separator for a nonaqueous electrolyte secondary battery according to claim 1, wherein the anti-short-circuit strength is 2.6 kgf or more.

4. The separator for a nonaqueous electrolyte secondary battery according to claim 1, wherein the separator resistance is 0.8 ohm or less.

5. The separator for a nonaqueous electrolyte secondary battery according to claim 1, wherein the glass fibers have an average fiber diameter of 0.4 μm or more and 0.8 μm or less.

6. The separator for a nonaqueous electrolyte secondary battery according to claim 1, wherein the glass fibers contain glass fibers having an average fiber diameter of 0.2 μm or more and 0.4 μm or less and glass fibers having an average fiber diameter of 0.5 μm or more and 0.8 μm or less, which are mixed with each other.

7. The separator for a nonaqueous electrolyte secondary battery according to claim 1, wherein a content of the glass fibers is 60% by mass or more and 90% by mass or less based on the total amount of fibers.

8. The separator for a nonaqueous electrolyte secondary battery according to claim 1, wherein the separator contains organic fibers in an amount of 1% by mass or more and 35% by mass or less based on the total amount of fibers, and contains a binder in an amount of 5% by mass or more and 35% by mass or less based on a mass obtained by subtracting a mass of the MgO from the total mass of the separator.

9. The separator for a nonaqueous electrolyte secondary battery according to claim 8, wherein the organic fibers contain fibrillated organic fibers in an amount of 1% by mass or more and 10% by mass or less based on the total amount of fibers.

10. The separator for a nonaqueous electrolyte secondary battery according to claim 1, wherein the MgO is added to make a product of a specific surface area by the BET method (m²/g) and a addition proportion by mass (wt %) with respect to the whole glass fiber of 300 ((m²/g)·(wt %)) or more.

11. A nonaqueous electrolyte secondary battery comprising the separator for a nonaqueous electrolyte secondary battery according to claim 1.
